(19) United States
(12) Patent Application Publication
(10) Pub. No.: US 2009/0204607 A1
(43) Pub. Date: Aug. 13, 2009

(54) DOCUMENT MANAGEMENT METHOD, DOCUMENT MANAGEMENT APPARATUS, INFORMATION PROCESSING APPARATUS, AND DOCUMENT MANAGEMENT SYSTEM

(75) Inventor: Noriko Matsuzawa, Soka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/365,749

(22) Filed: Feb. 4, 2009

(30) Foreign Application Priority Data
Feb. 8, 2008 (JP) 2008-029583

(51) Int. Cl. G06F 17/30

(52) U.S. Cl. 707/5; 707/E17.037

(57) ABSTRACT

When registering a document, pieces of index candidate information to be assigned to the document to be registered are created and output based on user characteristic information acquired from login information of a user and document information acquired from the document to be registered. Index information selected by the user from the pieces of output index candidate information is received. The received index information is registered in association with the document acquired by a document information acquiring unit. When browsing a document, the user characteristic information acquired from the login information of the user is compared with user characteristic information set for the registered document in association with the index information. A document having user characteristic information whose predetermined items match items of the set user characteristic information is extracted as a document associated with the user.

### BACKGROUND OF THE INVENTION

1. Field of the Invention

The present invention relates to a document management method, document management apparatus, information processing apparatus, and document management system. For example, the present invention relates to a technique of managing documents by, for example, assigning, when registering document data using user characteristics such as a department affiliation and a post, index information to be used to retrieve document data afterward.

2. Description of the Related Art

In many current document management systems, an administrator sets the category of index information in advance. Then, index values corresponding to index names are set upon document registration. In many cases, a general user selects and sets one of the index values input by the administrator in advance, or inputs and sets an arbitrary value as an index value. Index information is defined as information including a category (indicating the items/item names of the indices) and index values (indicating values set for the index items).

A user can retrieve document data and specify desired document data using index information set for the document data.

However, the above-described use of general users does not necessarily ensure uniformity in the character strings of all pieces of index information set by users. For example, if similar character strings have the same meaning but are not completely identical (for example, there is a difference in expression between “document storage” and “document registration”), retrieval by index information may fail in obtaining hits on documents.

In some systems, when a general user performs retrieval by index information, hits are obtained even on documents which are not directly associated with the user (e.g., documents created in another department and set in a reference disable state). In this case, when the user is going to open one of the actually hit documents, it may be found that he/she has no access rights to it.

As prior art to solve this problem, a system has been proposed to adopt appropriate index information when performing an OCR process for scan data and acquiring index information from the result. First, it is determined using a “language database” whether a word obtained as a result of the OCR process is a common word. Next, it is determined using a “knowledge database” whether the word has been adopted in the past. If it is determined that the word can be appropriate index information, it is adopted as index information (Japanese Patent Laid-Open No. 2006-172083).

Another prior art work to solve the above problem provides a system which executes user authentication. The user inputs index information serving as a retrieval keyword, and retrieval is performed using the input index information. This retrieval is done, in consideration of the user's access right, for only documents for which the user has an access right (Japanese Patent Laid-Open No. 2001-344245).

An object of index information setting in registering a document in the document management system is to “reuse stored documents or information”. Since the documents are registered on the system, not only the registrant but all system users will reuse them. However, document data registered on the system are not necessarily important for all system users. For example, document data registered by registrants who are engaged in the same work and belong to the same organization are greatly associated with other users who have highly similar user characteristics to the registrants, and it is desirable to expedite reuse of the document data.

However, if the users who register document data use various terms as the index information to be set for the documents, retrieval fails in hitting some document data so the object is not easy to achieve.

When paper data is to be scanned by, for example, a multi-function peripheral, assigned index information, and stored in the document management system, index information setting on the small user interface (UI) window of the multi-function peripheral is very cumbersome. This may result in time-consuming input or input errors.

In Japanese Patent Laid-Open No. 2006-172083, index information can be set using a term which has been used in the past by all users who use the system. However, there is no mention about how to make a user use the logs of only users close to him/her in terms of the department or project. Hence, even a term used in the past by a user in a different field of charge is set as index information.

In Japanese Patent Laid-Open No. 2001-344245, retrieval is performed in consideration of the user's access rights. To do this, it is necessary to set access rights for each document at registration time. When a user who is engaged in a plurality of projects and therefore has access rights in a wide range wants to retrieve only documents associated with a specific project or department, he/she must find a desired document from a plurality of hit documents.

### SUMMARY OF THE INVENTION

The present invention has been made to solve the above problems, and has as its object to provide a document management method, document management apparatus, information processing apparatus, and document management system capable of automatically collecting index candidate information based on user characteristics.

It is another object of the present invention to provide a document management method, document management apparatus, information processing apparatus, and document management system capable of collecting even index candidate information corresponding to document information.

It is still another object of the present invention to provide a document management method, document management apparatus, information processing apparatus, and document management system capable of easily setting uniform index information, unlike the prior art where index information setting is cumbersome.

In order to solve the above problems, a document management apparatus according to the present invention comprises: a user characteristic information acquiring unit adapted to acquire user characteristic information for identifying a user from login information of the user; a document information acquiring unit adapted to acquire document information of a document; an index candidate information creation unit adapted to create pieces of index candidate information to be assigned to the document based on the user characteristic information acquired by the user characteristic information acquiring unit and the document information acquired by the document information acquiring unit; an index candidate information output unit adapted to output the pieces of index candidate information created by the index candidate information creation unit; an index information reception unit adapted to receive index information selected by the user from the pieces of index candidate information output by the index candidate information output unit; and a document registration unit adapted to register the index information received by the index information reception unit in association with the document acquired by the document information acquiring unit.

A method of managing documents according to the present invention comprises the steps of: acquiring user characteristic information for identifying a user from login information of the user; acquiring document information of a document; creating pieces of index candidate information to be assigned to the document based on the user characteristic information acquired in the user characteristic information acquiring step and the document information acquired in the document information acquiring step; outputting the pieces of index candidate information created in the index candidate information creating step; receiving index information selected by the user from the pieces of index candidate information output in the index candidate information outputting step; and registering the index information received in the index information receiving step in association with the document acquired in the document information acquiring step.

A document management apparatus according to the present invention comprises a mail reception unit adapted to receive mail; a user characteristic information acquiring unit adapted to acquire user characteristic information for identifying a user from a transmission source address of the received mail; a document information acquiring unit adapted to acquire document information from an attached file of the received mail; an index information creation unit adapted to create index information to be assigned to the document based on the user characteristic information acquired by the user characteristic information acquiring unit and the document information acquired by the document information acquiring unit; a document registration unit adapted to register the index information created by the index information creation unit, in association with the document acquired by the document information acquiring unit; and a mail transmission unit adapted to transmit the mail representing completion of document registration to the transmission source address, the mail having a text containing the index information created by the index information creation unit.

A method of managing documents according to the present invention comprises the steps of: receiving mail; acquiring user characteristic information for identifying a user from a transmission source address of the received mail; acquiring document information from an attached file of the received mail; creating index information to be assigned to the document based on the user characteristic information acquired in the user characteristic information acquiring step and the document information acquired in the document information acquiring step; registering the index information created in the index information creating step in association with the document acquired in the document information acquiring step; and transmitting the mail representing completion of document registration to the transmission source address, the mail having a text containing the index information created in the index information creating step.

An information processing apparatus according to the present invention comprises a login unit adapted to log in to a document management apparatus for registering and managing documents; a document transmission unit adapted to transmit a document to be registered; an index candidate information reception unit adapted to receive pieces of index candidate information created and output by the document management apparatus based on user characteristic information acquired from login information and document information acquired from the document; and an index information transmission unit adapted to transmit index information selected by a user from the pieces of received index candidate information to register the index information in association with the document to be registered.

A method of controlling an information processing apparatus according to the present invention comprises the steps of: logging in to a document management apparatus for registering and managing documents; transmitting a document to be registered; receiving pieces of index candidate information created and output by the document management apparatus based on user characteristic information acquired from login information and document information acquired from the document; and transmitting index information selected by a user from the pieces of received index candidate information to register the index information in association with the document to be registered.

A document management system including an information processing apparatus for registering and browsing documents, and a document management apparatus for managing the registered documents according to the present invention, the document management apparatus comprises: a user characteristic information acquiring unit adapted to acquire user characteristic information for identifying a user from login information of the user; a document information acquiring unit adapted to acquire document information of a document; an index candidate information creation unit adapted to create pieces of index candidate information to be assigned to the document based on the user characteristic information acquired by the user characteristic information acquiring unit and the document information acquired by the document information acquiring unit; an index candidate information output unit adapted to output the pieces of index candidate information created by the index candidate information creation unit; an index information reception unit adapted to receive index information selected by the user from the pieces of index candidate information output by the index candidate information output unit; and a document registration unit adapted to register the index information received by the index information reception unit in association with the document acquired by the document information acquiring unit.

A method of managing documents in a document management system including an information processing apparatus for registering and browsing the documents, and a document management apparatus for managing the registered documents according to the present invention comprises the steps of: acquiring user characteristic information for identifying a user from login information of the user; acquiring document information of a document; creating index candidate information to be assigned to the document based on the user characteristic information acquired in the user characteristic information acquiring step and the document information acquired in the document information acquiring step; displaying the pieces of index candidate information created in the index candidate information creating step; receiving index information selected by the user from the pieces of index candidate information displayed in the index candidate information displaying step; and registering the index information received in the index information receiving step in association with the document acquired in the document information acquiring step.

According to the present invention, setting of user characteristics makes it possible to cause a user to automatically retrieve and collect index candidate information associated with him/her without becoming conscious of uniformity in index information.

This saves a general user from designating a plurality of character string expressions as retrieval keywords.

Since a user interface which allows a user to select index candidate information is displayed, he/she need not input index information one by one on a small window of, for example, a multi-function peripheral.

Further features of the present invention will become apparent from the following description of exemplary embodiments with reference to the attached drawings.

### BRIEF DESCRIPTION OF THE DRAWINGS

FIG. 1 is a view showing the concept of a document management system according to the embodiments;

FIG. 2 is a block diagram showing the hardware configuration of a PC in the document management system according to the embodiments;

FIG. 3 is a block diagram showing the software configuration of the document management system according to the embodiments;

FIG. 4 is a view showing the outline of the login and user characteristics registration process of the document management system according to the embodiments;

FIG. 5 is a flowchart illustrating the login and user characteristics registration process of the document management system according to the embodiments;

FIG. 6 is a view showing an example of a user characteristic table in the document management system according to the embodiments;

FIG. 7 is a view showing the outline of the document registration process of the document management system according to the embodiments;

FIG. 8 is a flowchart illustrating the sequence of the document registration process of the document management system according to the first embodiment;

FIG. 9 is a view showing the outline of a weighting process when accessing a document in the document management system according to the embodiments;

FIG. 10 is a flowchart illustrating the sequence of the weighting process when accessing a document in the document management system according to the embodiments;

FIG. 11 is a view showing the outline of a document collection process upon login to the document management system according to the embodiments;

FIG. 12 is a flowchart illustrating the sequence of the document collection process upon login to the document management system according to the embodiments;

FIG. 13 is a view showing an example of a user interface which displays a document collection result after login to the document management system according to the embodiments;

FIG. 14 is a view showing the outline of the document registration process of the document management system according to the embodiments;

FIG. 15 is a view showing an example of index candidate information creation in the document management system according to the embodiments;

FIG. 16 is a flowchart illustrating the sequence of the index candidate information creation process when registering a document in the document management system according to the embodiments;

FIG. 17 is a flowchart illustrating the sequence of an index candidate information addition process when creating index candidate information in the document management system according to the embodiments;

FIG. 18 is a flowchart illustrating the sequence of an index setting log information storage process when registering a document in the document management system according to the embodiments;

FIG. 19 is a view showing an example of a user interface for document registration/index information registration in the document management system according to the embodiments;

FIG. 20 is a view showing an example of a user interface for advanced retrieval by index information of registered documents in the document management system according to the embodiments; and

FIG. 21 is a flowchart illustrating the sequence of a process of automatically storing an attached file assigned index information upon receiving mail with the attached file in a document management system according to the second embodiment.

### DESCRIPTION OF THE EMBODIMENTS

An embodiment of the present invention will now be described with reference to the accompanying drawings.

### Example of Arrangement of Document Management System of Embodiment

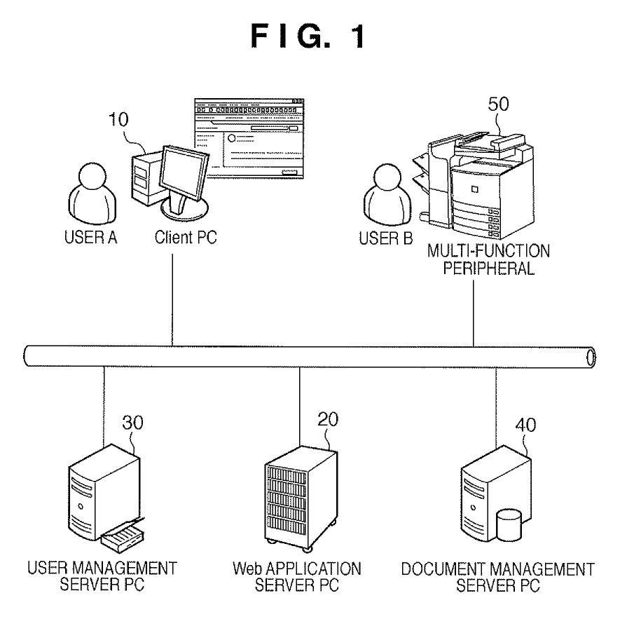

FIG. 1 is a view showing the arrangement of a document management system according to the embodiment. In the present invention, a document management application to provide the functions of a document management system to, for example, a user A and a user B is provided as a Web service (Web application).

Referring to FIG. 1, the following devices are connected to the document management system of the embodiment via a network. A Client PC 10 to cause the user A to access the Web application to provide the functions of the document management system via a Web browser is connected. A Web application server PC 20 which provides the Web application of the document management system of the embodiment is also connected. A user management server PC 30 which manages the information of a user who accesses the system is also connected. A document management server PC 40 having a function of storing/managing documents is also connected. A multi-function peripheral 50 serving as an image forming apparatus which has a scanner function, printer function, facsimile function and is accessed by the user B via a UI (in this embodiment, the UI is internally displayed using a browser) is also connected.

The Web application server PC 20, user management server PC 30, and document management server PC 40 are separately arranged. However, these functions may be prepared in one PC. The user A operates the Client PC 10. However, the user may operate one of the three server PCs or a PC that is identical to these server PCs. The user B operates the multi-function peripheral 50. However, a scanner may be connected to the Client PC 10.

The document management system according to the embodiment is designed to make the user A access it via a Web browser and make the user B access it via the UI of the multi-function peripheral. However, a dedicated client application (not shown) may be installed in the Client PC 10 or the multi-function peripheral 50 and operated by the user A or the user B. In this case, not the Web application server PC 20 but the document management server PC 40 may communicate with the dedicated client application.

### Example of Hardware Configuration of PC of Embodiment

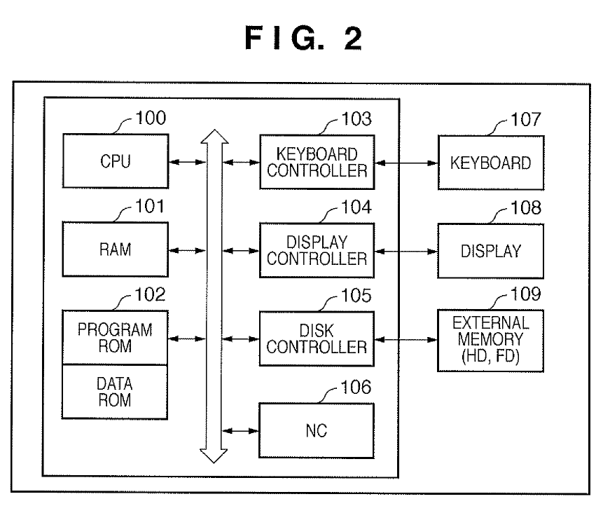

FIG. 2 shows an example of the hardware configuration of each PC included in the document management system according to the embodiment. The hardware configuration shown in FIG. 2 is equivalent to that of a general information processing apparatus. The hardware configuration of a general information processing apparatus is applicable to each PC of the embodiment.

Referring to FIG. 2, a CPU 100 executes programs such as an OS and application programs stored in the program ROM of a ROM 102 or loaded from a hard disk 109 to a RAM 101. “OS” is short for an operating system which runs on a computer. The operating system will be referred to as an OS hereinafter. The processes of flowcharts to be described later can be implemented by executing programs under the control of the OS. The RAM 101 functions as the main memory or work area of the CPU 100. A keyboard controller 103 controls key input from a keyboard 107 or a pointing device (not shown). A display controller 104 controls display on various kinds of displays 108. A disk controller 105 controls data access to, for example, the hard disk (HD) 109 or floppy® disk (FD) which stores various kinds of data. An NC 106 is connected to a network to execute a communication control process for another device connected to the network.

### Example of Software Configuration of Document Management System of Embodiment

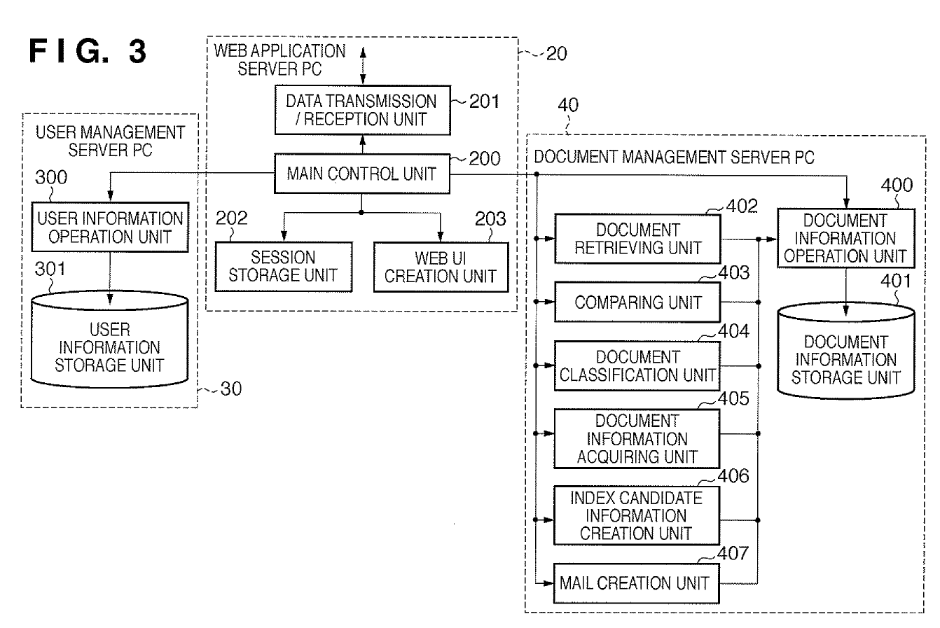

FIG. 3 is a block diagram showing an example of the software configuration of the document management system according to the embodiment. FIG. 3 shows the software configurations of the Web application server PC 20, user management server PC 30, and document management server PC 40.

Referring to FIG. 3, a main control unit 200 in the Web application server PC 20 controls the overall document management system according to the embodiment, thereby sending instructions to the units (to be described later) and managing them. A data transmission/reception unit 201 receives an instruction input by the user via the browser in the Client PC 10 or the multi-function peripheral 50, and returns a result from the main control unit 200 to the Client PC 10 or the multi-function peripheral 50. When the user accesses the document management system via the browser in the Client PC 10 or the multi-function peripheral 50, a session storage unit 202 creates session information representing the access from a single user. The session storage unit 202 holds various kinds of information to be repeatedly used in association with the session information until the user stops accessing the document management system (logout), or the session ends due to, for example, automatic timeout. A Web UI creation unit 203 creates a Web UI (HTML) according to a situation upon receiving an instruction from the main control unit 200. The Web UI created by the Web UI creation unit need not always be HTML and may contain a script language such as Java® script.

A user information operation unit 300 in the user management server PC 30 performs, in accordance with an instruction from the main control unit 200, operations such as extraction and editing of users, who can access the document management system, and user characteristics which are stored in a user information storage unit 301. The user management need not be unique to the document management system. The user information operation unit 300 may cooperate with a known technique such as ActiveDirectory or LDAP, and the user information storage unit 301 may store only user characteristics.

A document information operation unit 400 in the document management server PC 40 performs, in accordance with an instruction from the main control unit 200, operations such as registration, storing, extraction, and edition of actual documents and document attributes including index information, which are stored in a document information storage unit 401. A document retrieving unit 402 determines a document retrieving method and acquires a retrieval result from the document information storage unit 401 via the document information operation unit 400 in accordance with an instruction from the main control unit 200. A comparing unit 403 compares document attributes with user characteristics in accordance with an instruction from the main control unit 200, and changes the weighting of the attributes of a document stored in the document information storage unit 401 as needed. A document classification unit 404 executes classification based on the count (weighting) values of document attributes and returns the result to the main control unit 200 in accordance with an instruction from the main control unit 200. A document information acquiring unit 405 executes image processing such as an OCR process for document data received by the data transmission/reception unit 201 and acquires document information in accordance with an instruction from the main control unit 200. An index candidate information creation unit 406 creates index candidate information using information acquired from the user information operation unit 300 and the document information acquiring unit 405 in accordance with an instruction from the main control unit 200. A mail creation unit 407 creates a mail header and text to notify the user of a document registration result or the like using information acquired from the user information operation unit 300 and the document information acquiring unit 405 in accordance with an instruction from the main control unit 200. The created mail is transmitted by the main control unit 200 via the data transmission/reception unit 201 or by the mail creation unit 407.

### Example of Process of Document Management System of First Embodiment

The process in each step of the document management system according to the first embodiment of the present invention will be described below in detail with reference to FIGS. 1 to 19.

(Login and User Characteristics Registration Process)

In this process, the user A accesses (logs in to), via the browser of the Client PC 10, the Web application to provide the functions of the document management system, and in the first login, inputs user characteristics, and stores them in the document management system.

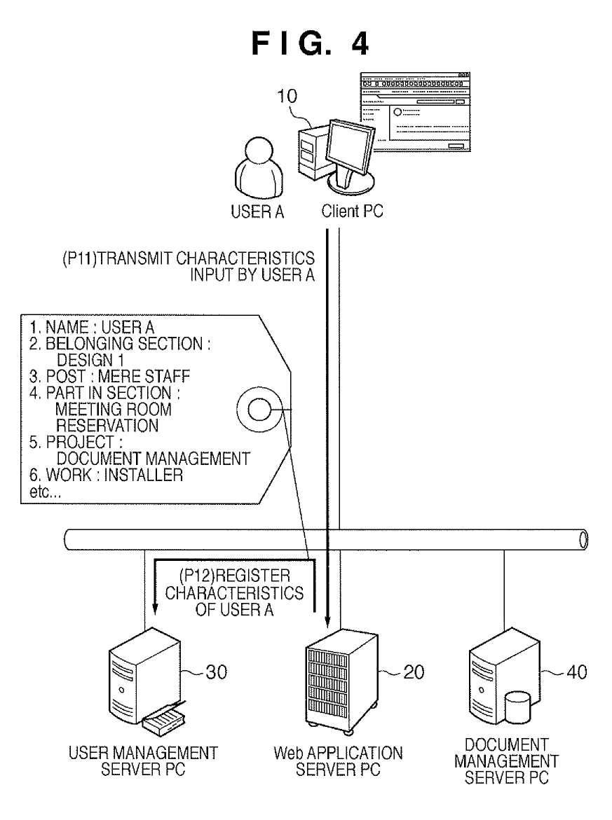

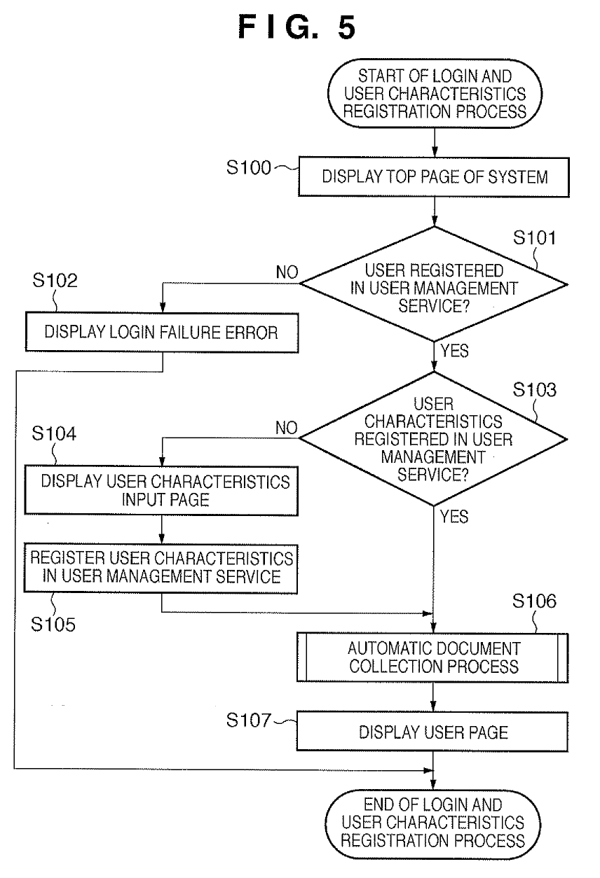

FIG. 4 shows the outline of the system operation of the login and user characteristics registration process of the document management system. FIG. 5 is a flowchart illustrating an example of the sequence of the login and user characteristics registration process of the document management system. This flowchart represents the process of the main control unit 200 in the Web application server PC 20. The login and user characteristics registration process will be described below in detail with reference to FIGS. 4 and 5.

In step S100, the user A accesses, via the browser of the Client PC 10, the top page of the Web application to provide the functions of the document management system. The main control unit 200 receives a request via the data transmission/reception unit 201 and sends it to the Web UI creation unit 203 to create the top page. The top page of the document management system is returned to the Client PC 10 via the data transmission/reception unit 201 as a response and displayed on the Web browser of the Client PC 10.

In step S101, the user A inputs login information to the top page displayed in step S100. The main control unit 200 receives the login information of the user A via the data transmission/reception unit 201. The main control unit 200 sends an inquiry to the user information operation unit 300 and confirms whether the user A who has logged in is a user registered in the user information storage unit 301. If the user A does not exist in the user information storage unit 301, or the password is wrong, the main control unit 200 sends a request to the Web UI creation unit 203 to create a login failure error page in step S102. The login failure error page is returned to the Client PC 10 via the data transmission/reception unit 201 as a response and displayed on the Web browser of the Client PC 10.

If it is determined in step S101 that the user A has already been registered in the user information storage unit 301, the main control unit 200 causes the session storage unit 202 to create session information in step S103. Then, the main control unit 200 sends an inquiry to the user information operation unit 300 and confirms whether the user characteristics of the user A are registered in the user information storage unit 301. The session information creation timing is not limited to here.

If it is determined in step S103 that the user characteristics of the user A have not been registered, the main control unit 200 requests the Web UI creation unit 203 to create a user characteristics input page in step S104. The user characteristics input page is returned to the Client PC 10 via the data transmission/reception unit 201 as a response and displayed on the Web browser of the Client PC 10. In step S105, the user A inputs the user characteristics to the user characteristics input page displayed in step S104. The main control unit 200 causes the Web application to receive the user characteristics of the user A via the data transmission/reception unit 201 and acquire user characteristic information (process P11 in FIG. 4).

Next, the main control unit 200 instructs the user information operation unit 300 to register the user characteristics of the user A in the user information storage unit 301 (process P12 in FIG. 4). At this time, the main control unit 200 also instructs the session storage unit 202 to hold the user characteristics together with the created session information. Since it is unnecessary to acquire the user characteristic information of the user A from the user information storage unit 301 each time, the process speed can increase.

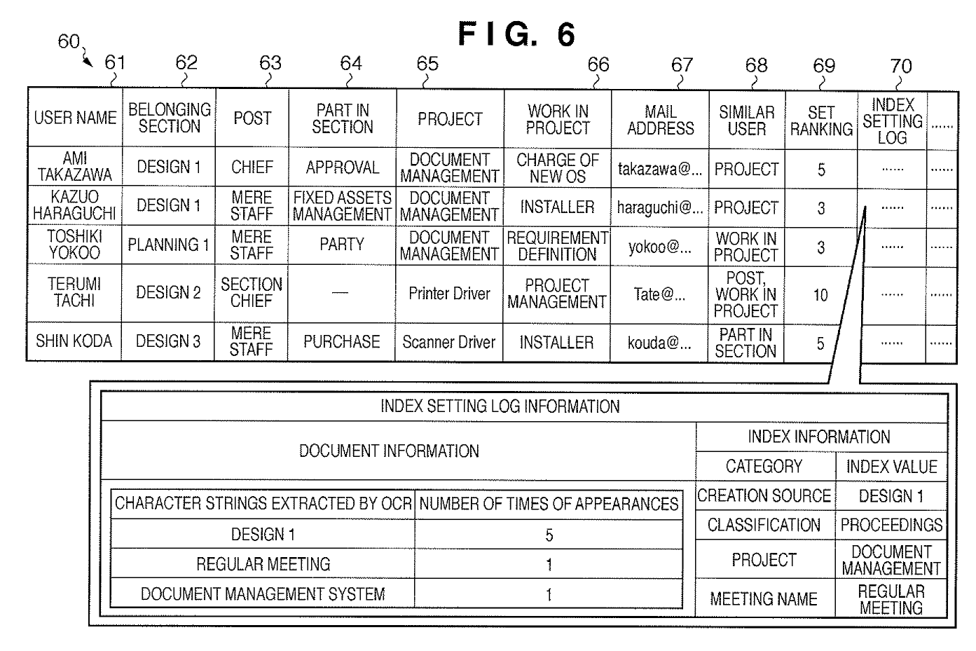

FIG. 6 is a view showing the structure of user characteristics and an example of the user characteristic table 60 stored in the user information storage unit 301.

User characteristics corresponding to each user name 61 include a belonging section 62, post 63, part 64 in section, project 65, work 66 in project, mail address 67, similar user 68, set ranking 69, and index setting log 70. The user characteristics are used in an automatic document collection process to be described later. The similar user 68 designates a predetermined key to be used to specify similar users when collecting information of similar users. The set ranking 69 designates, as an example of document information, the lowest ranking place of information to be stored based on the number of times of appearance of each character string extracted by the OCR process. The index setting log 70 is the log information of index information set for the document in correspondence with the acquired document information.

Note that the user characteristics may include any other information. Each item of the user characteristics may have a plurality of values. For example, it is preferable to allow selection of a plurality of values for a user involved in a plurality of projects. In the user characteristics input page, the user preferably selects the items of user characteristics instead of freely inputting the items. To do this, the administrator or the like at the installation location of the document management system preferably sets appropriate selection items in advance in accordance with the user environment of the installation location.

If it is determined in step S103 that the user characteristics have been registered, or the user characteristics are registered in step S105, an automatic document collection process (to be described later) corresponding to the user characteristics of the user A is executed in step S106. In step S107, the main control unit 200 causes the Web UI creation unit 203 to create the page of the user A based on the display contents collected and classified in accordance with the user characteristics of the user A in step S106. The page of the user A is returned to the Client PC 10 via the data transmission/reception unit 201 as a response and displayed on the Web browser of the Client PC 10.

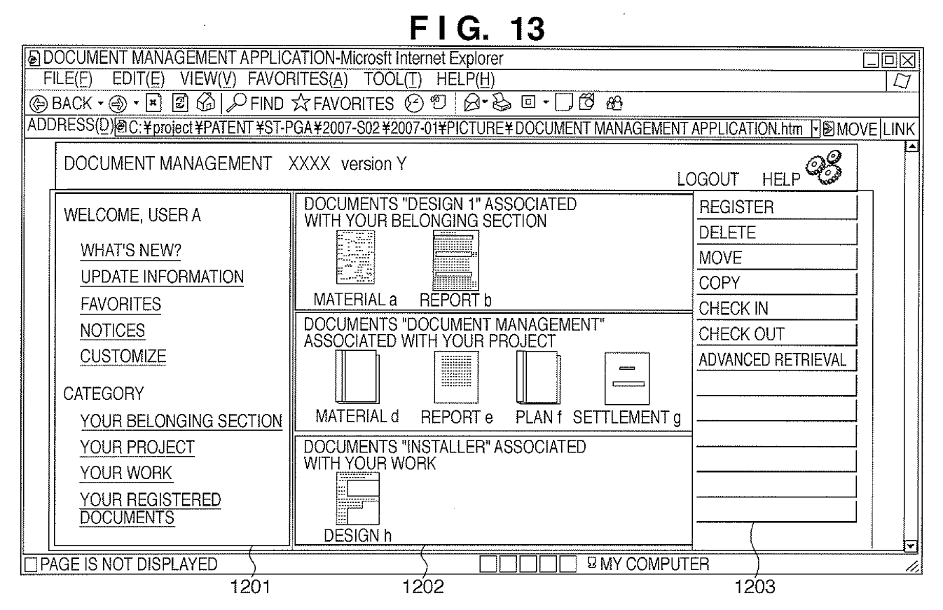

FIG. 13 shows an example of the page of the user A displayed on the Client PC 10 in step S107, which includes the display contents collected and classified in accordance with the user characteristics. This will be explained in detail in association with the automatic document collection process.

(Document Registration Process)

In this process, a user accesses (logs in to), via the browser of the Client PC 10, the Web application to provide the functions of the document management system, designates a document, and registers it in the document management system. Alternatively, a user accesses, via the UI of the multi-function peripheral 50, the Web application of the document management system, designates a document, and registers it in the document management system.

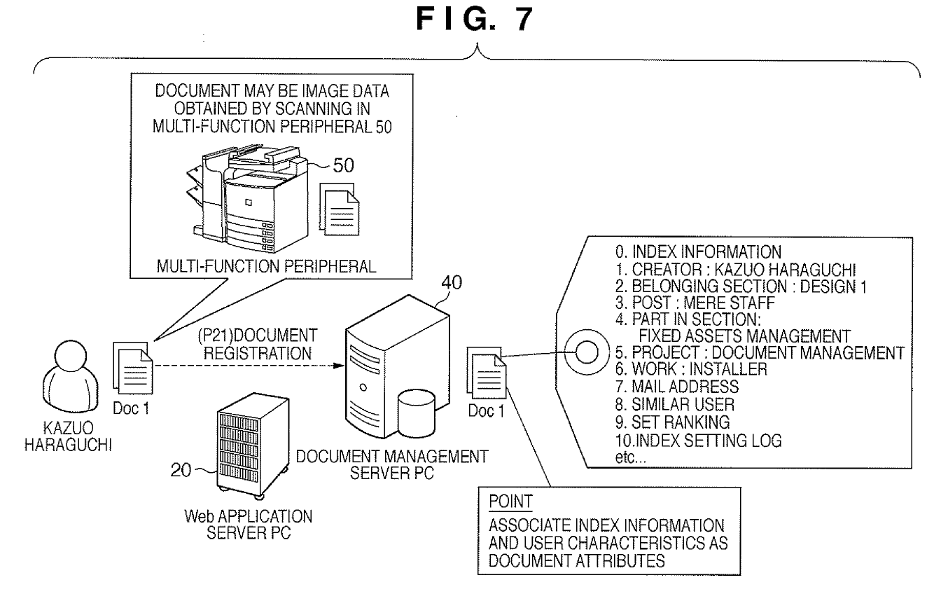

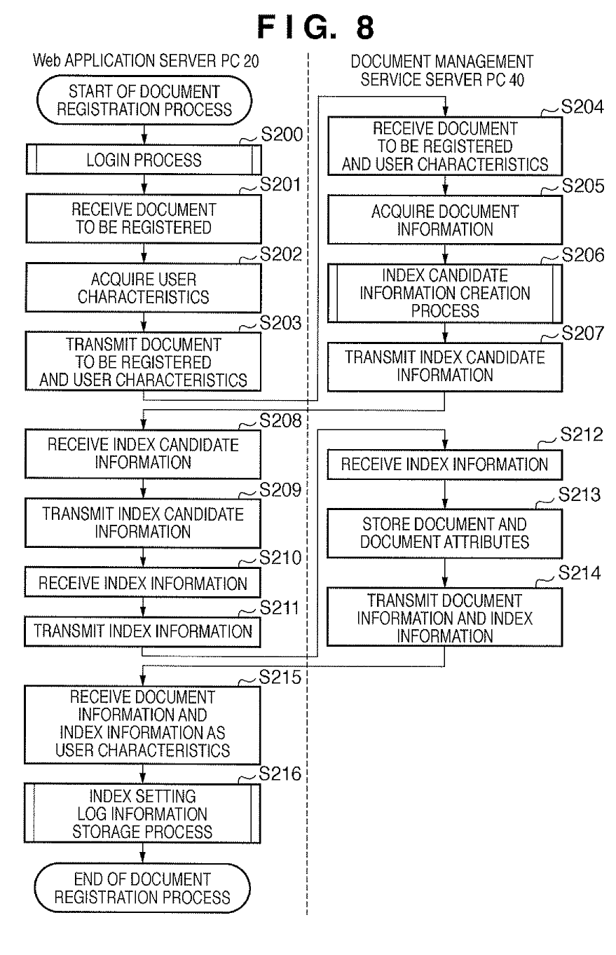

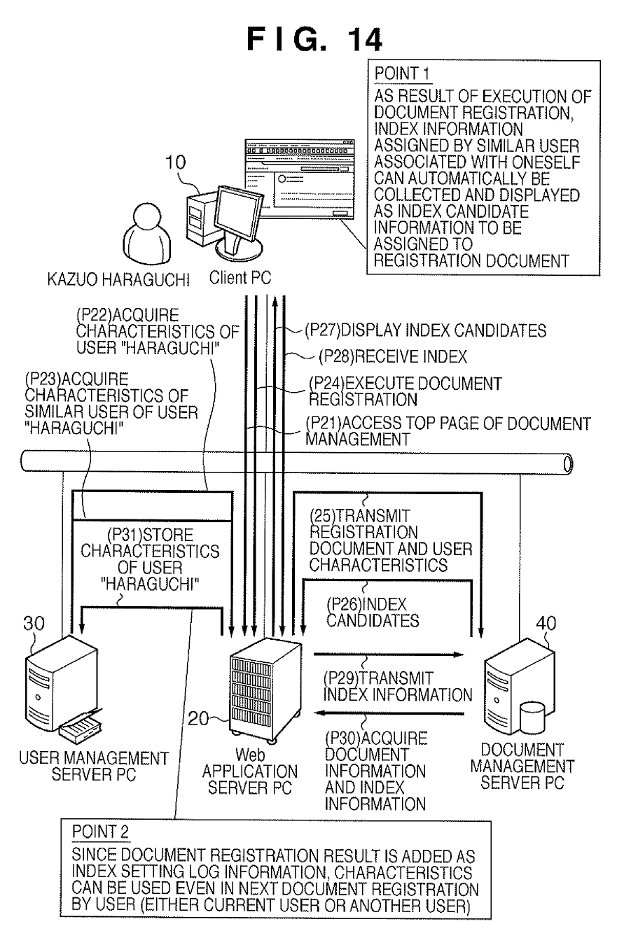

FIG. 7 shows the outline of the system operation of the document registration process of the document management system. FIG. 8 is a flowchart illustrating the sequence of the document process of the document management system. FIG. 14 is a view for explaining the outline of the process of registering a document in the document management system.

The process will be described below in detail with reference to FIGS. 7, 8, and 14. Only document registration (process P20 in FIG. 7) from the Client PC 10 will be explained here. However, the document to be registered from the Client PC 10 can be replaced with a document containing image data obtained by scanning in the multi-function peripheral 50.

Steps S200 to S203 are the processes of the main control unit 200 in the Web application server PC 20.

In step S200, a user (the following description will be made assuming that the user name is “Kazuo Haraguchi”) accesses, via the browser of the Client PC 10, the Web application to provide the functions of the document management system (process P21 in FIG. 14). The login process is the same as in the sequence of the login and user characteristics registration process of the document management system described with reference to FIG. 5.

Document registration is executed on the page of the user “Kazuo Haraguchi” displayed in step S200. In step S201, the main control unit 200 receives a document (the document name is “Doc1”) via the data transmission/reception unit 201 (process P24 in FIG. 14). The session storage unit 202 temporarily stores the document information associated with session information. This process includes the document transmission process of the client and the document reception process of the server.

In step S202, the main control unit 200 acquires the user characteristics of the user “Kazuo Haraguchi” held by the session storage unit 202 in step S200. Note that the main control unit 200 may instruct the user information operation unit 300 to acquire the user characteristics of the user “Kazuo Haraguchi” and the user characteristics of similar users who match a predetermined key from the user information storage unit 301, as indicated by processes P22 and P23 in FIG. 14.

In step S203, the main control unit 200 transmits the registration document and the user characteristics acquired in steps S201 and S202 to the document management server PC 40 via the data transmission/reception unit 201 (process P25 in FIG. 14). In this case, transmission of the registration document and the user characteristics is assumed. However, an implementation system for directly transmitting information from the user management server PC 30 to the document management server PC 40 may be employed, although not illustrated in FIG. 14.

Steps S204 to S207 are the processes of the units in the document management server PC 40.

In step S204, the document management server PC 40 receives, from the Web application server PC 20, the registration document and the user characteristics acquired in steps S201 and S202. In step S205, the document information acquiring unit 405 acquires document information from the registration document acquired in step S201 by performing image processing such as an OCR process or character string extraction using, for example, a full-text search. Note that acquisition of attributes and the like already set for the document may be executed in addition to the above-described image processing.

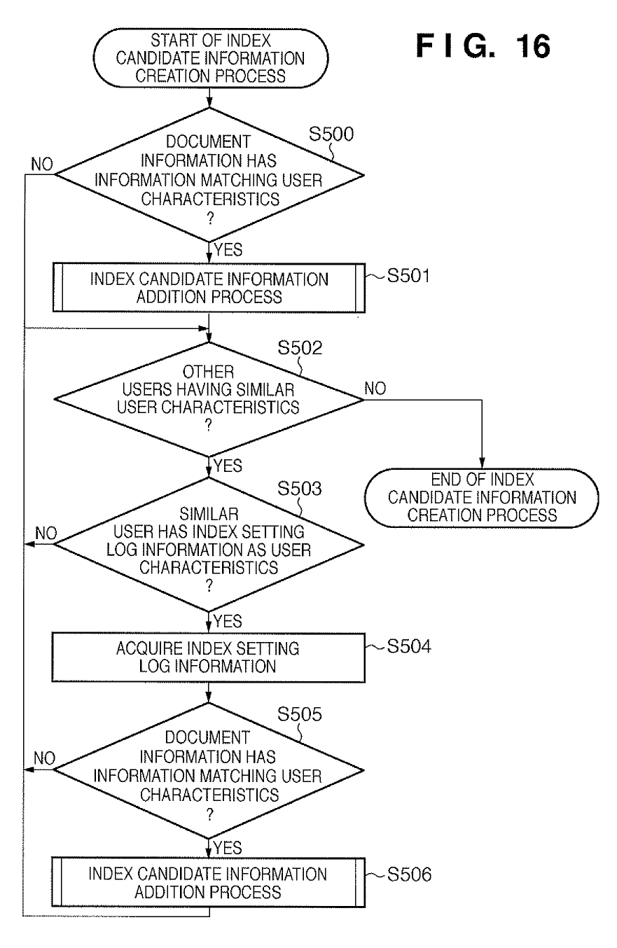

In step S206, pieces of index candidate information are created based on the user characteristics acquired in step S202 and the document information acquired in step S205. The index candidate information creation process will be described later in detail with reference to FIG. 16. In step S207, the document management server PC 40 transmits the index candidate information to the main control unit 200 via the data transmission/reception unit 201, as indicated by a process P26 in FIG. 14.

Steps S208 to S211 are the processes of the main control unit 200 in the Web application server PC 20.

In step S208, the main control unit 200 receives the index candidate information from the document management server PC 40. In step S209, the main control unit 200 causes the Web UI creation unit 203 to create an index information setting page using the received index candidate information. Next, the main control unit 200 outputs information about the index information setting page based on the index candidate information to the Client PC 10 via the data transmission/reception unit 201. The index information setting page is displayed on the Web browser of the Client PC 10 (process P27 in FIG. 14). This process includes the index candidate information output process, index candidate information transmission process, and display instruction process of the server, and the index candidate information reception process and index candidate information display process of the client.

In step S210, the main control unit 200 receives, via the data transmission/reception unit 201, index information designated by the user on the index information setting page of the Client PC 10 (process P28 in FIG. 14). This process includes the index information transmission process of the client and the index information reception process of the server.

In step S211, the main control unit 200 transmits the index information received in step S210 to the document management server PC 40 via the data transmission/reception unit 201, as indicated by a process P29 in FIG. 14.

Steps S212 to S214 are the processes of the units in the document management server PC 40.

In step S212, the document management server PC 40 receives the index information transmitted via the data transmission/reception unit 201 in step S211. In step S213, the document information operation unit 400 is instructed to store, in the document information storage unit 401, the document Doc1 stored in the session storage unit 202 in step S201. In this process, the user characteristics of the user “Kazuo Haraguchi” acquired by the session storage unit 202 in step S202 and the index information acquired in step S210 are stored as the attributes of the document Doc1. For example, as shown in FIG. 7, not only the index information but also the user characteristics of the user “Kazuo Haraguchi” are associated with the registered document Doc1.

Automatic classification is done by the automatic document collection process to be described later. Since it is unnecessary to designate a storage location in the document management system, the user who registers the document is released from the operation of determining the storage location.

In step S214, the document management server PC 40 transmits the document information and the index information stored in step S213 to the main control unit 200, as indicated by a process P30 in FIG. 14.

Steps S215 and S216 are the processes of the main control unit 200 in the Web application server PC 20.

In step S215, the main control unit 200 receives the document information and the index information transmitted from the document management server PC 40 in step S214. In step S216, the received document information and index information are added to the user characteristics of the user “Kazuo Haraguchi” stored in the user information storage unit 301 in step S105. They are stored in the user information storage unit 301 via the user information operation unit 300, as indicated by a process P31 in FIG. 14.

A process of storing user characteristics in the user information storage unit 301 in each document registration has been described. However, the main control unit 200 may update the user characteristics of “Kazuo Haraguchi” held by the session storage unit 202 and store them in the user information storage unit 301 at once at the end of a plurality of document registration processes. In step S216, all pieces of document information including all character strings extracted by the OCR process or all character strings extracted by a full-text search may be stored. However, not to use a memory capacity more than necessary, only character strings in the document at higher ranking places in terms of the number of times of appearance in the extraction by the OCR process are preferably stored in accordance with the set ranking of the user characteristics shown in FIG. 6.

(Document Attribute Weighting Process)

A user accesses (logs in to), via the browser of the Client PC 10, the Web application to provide the functions of the document management system, and accesses a document. The access includes operations such as browsing, printing, and copy. In this embodiment, browsing will be described as an example.

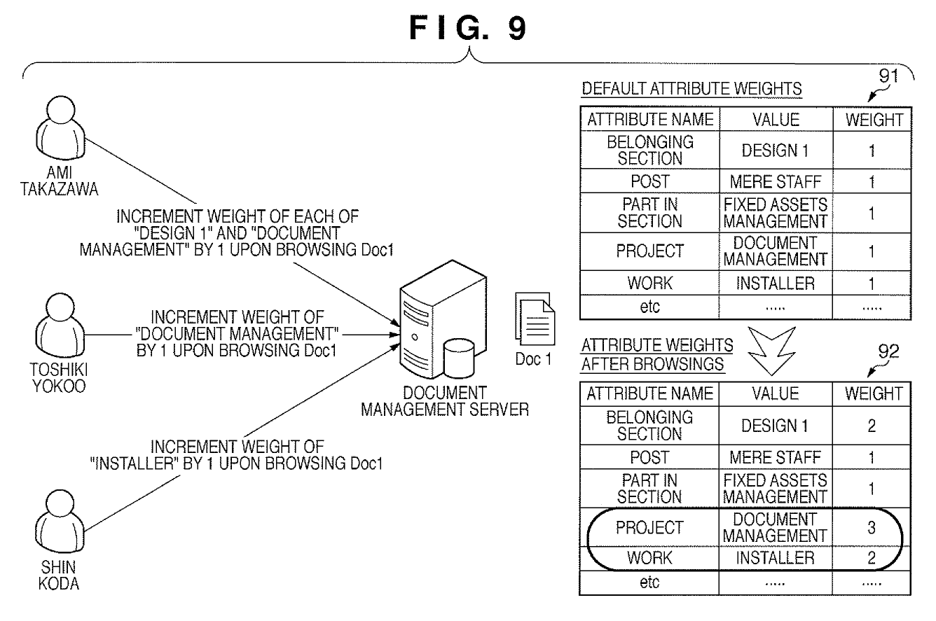

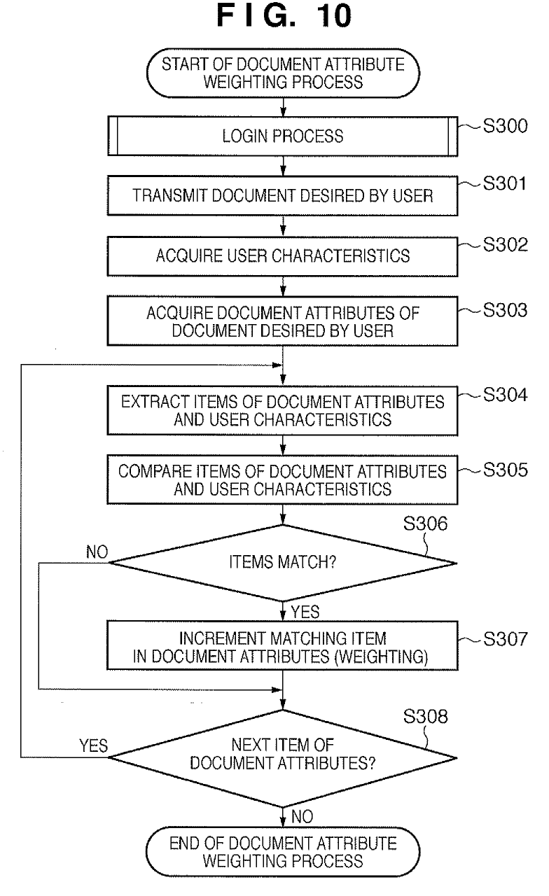

FIG. 9 shows the outline of the system operation of the document attribute weighting process of the document management system. FIG. 10 is a flowchart illustrating an example of the sequence of the document attribute weighting process of the document management system. The process will be described below in detail with reference to FIGS. 9 and 10. Note that the main control unit 200 of the Web application server PC 20 executes the document attribute weighting process while outputting process instructions to the units in the document management server PC 40. However, FIG. 10 illustrates not the instruction exchanges as in FIG. 8 but only the process of the main control unit 200 to avoid complexity.

In step S300, a user (the user name is assumed to be “Ami Takazawa”) accesses, via the browser of the Client PC 10, the Web application to provide the functions of the document management system. The login process is the same as in the sequence of the login and user characteristics registration process of the document management system described with reference to FIG. 5.

In step S301, the user selects a desired document and executes browsing on the page of the user “Ami Takazawa” displayed in step S300. The main control unit 200 receives the document (the document name is “Doc1” registered by the user “Kazuo Haraguchi” in the above-described registration process) via the data transmission/reception unit 201, and causes the session storage unit 202 to temporarily store the document associated with session information. The information to identify the document designated by the user “Ami Takazawa” for browsing and received via the data transmission/reception unit 201 need not always identify the document name. An ID to identify the document is also usable.

In step S302, the main control unit 200 acquires the user characteristics of the user “Ami Takazawa” held by the session storage unit 202 in step S300. Note that the main control unit 200 may instruct the user information operation unit 300 to acquire the user characteristics of the user “Ami Takazawa” from the user information storage unit 301.

In step S303, the main control unit 200 stores the document attributes of the document Doc1 stored in the session storage unit 202 in step S301. At this time, the main control unit 200 instructs the document information operation unit 400 to acquire the document attributes of the document Doc1 from the document information storage unit 401 and stores the document attributes in the session storage unit 202 in association with the session information.

In step S304, the main control unit 200 instructs the comparing unit 403 to extract the items of the document attributes and the user characteristics of the user “Ami Takazawa”. The document attributes are the document attributes of the document Doc1 acquired and stored in the session storage unit 202 in step S303. The user characteristics are the user characteristics of the user “Ami Takazawa” acquired in step S302. More specifically, the value of the first item “belonging section” of the document attributes of the document Doc1 is “design 1”. The value of the first item “belonging section” of the user characteristics of the user “Ami Takazawa” is also “design 1”. In step S305, the comparing unit 403 compares the item of the document attributes with that of the user characteristics, which are extracted in step S304, to determine whether the items have the same value.

If the comparing unit 403 determines in step S306 that the item of the document attributes and that of the user characteristics, which are compared by the comparing unit 403 in step S305, have the same value, the process in step S307 is executed. In step S307, the comparing unit 403 requests the document information operation unit 400 to update the weighting of the document attributes of the document Doc1 stored in the document information storage unit 401. More specifically, the weighting of the item “belonging section” of the document attributes of the document Doc1 is incremented, as shown in FIG. 9. In this embodiment, the weighting of each item of the document attributes stored in the document information storage unit 401 is updated based on the comparison result of the comparing unit 403. However, the comparison results of all items may be reflected at once.

If it is determined in step S306 that the item of the document attributes and that of the user characteristics have different values, it is confirmed in step S308 whether the next item of the document attributes exists. More specifically, “post” exists as the second item of the document attributes of the document Doc1. Hence, the process from step S304 is continued.

The processes in steps S304 to S308 are repeated. When the last item of the document attributes of the document Doc1 is extracted, and comparison with all items of the user characteristics is ended, the document attribute weighting process ends.

FIG. 9 shows a document attribute weighting 91 immediately after registration of the document Doc1 and the change result of a document attribute weighting 92 of the document Doc1 after the users “Ami Takazawa”, “Toshiki Yokoo”, and “Shin Koda” have browsed the document Doc1. Consequently, the weight value of “project” of the document attributes is larger than the weight value of “belonging section”. That is, the document Doc1 has a higher relevance to “document management” as a project than to “design 1” as a belonging section. At the time of classification of the automatic document collection process to be described later, it is possible to automatically determine that the relevance to “project” or “document management” as a project is high.

In this way, any one of attributes added to a document, which is supposed to have a higher relevance to the document itself, is weighted in every document access such as document browsing by a user who uses the document management system. This allows automatic collection (retrieval) of documents associated with a user.

(Automatic Document Collection Process)

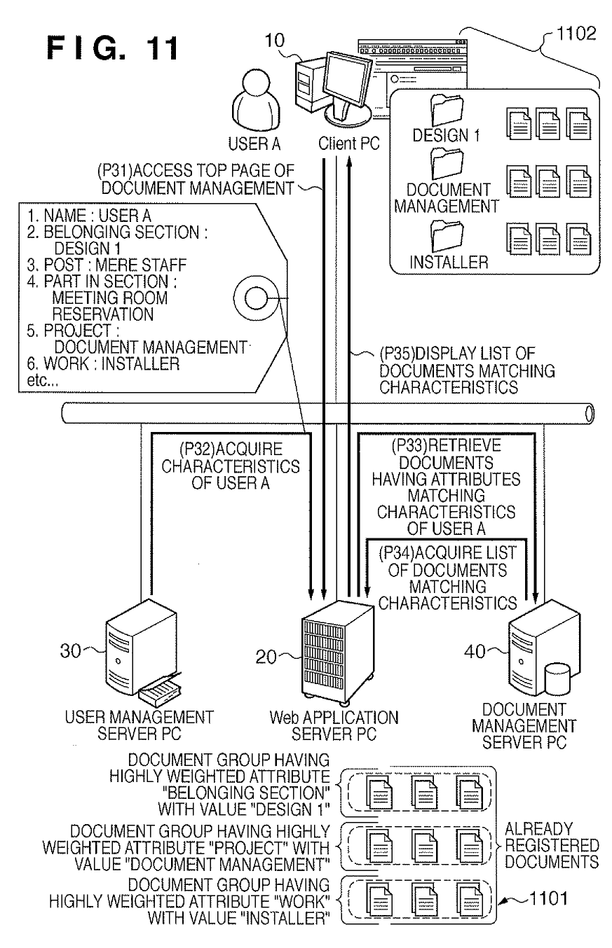

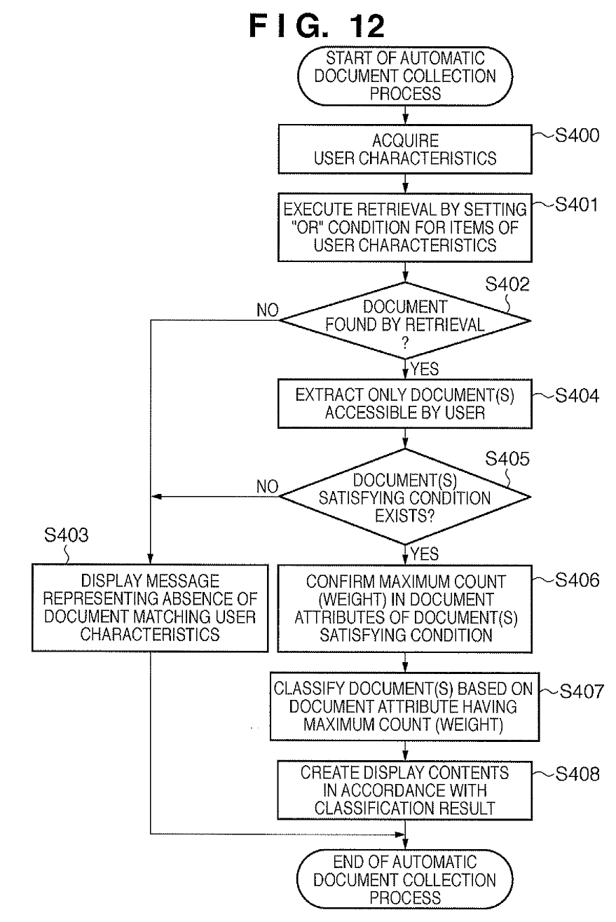

The user A accesses (logs in to), via the browser of the Client PC 10, the Web application to provide the functions of the document management system (process P31 in FIG. 11). The document collection process automatically runs, and a list of acquired documents is displayed on the browser of the Client PC 10. FIG. 11 shows the outline of the system operation of the automatic document collection process of the document management system. FIG. 12 is a flowchart illustrating the sequence of the automatic document collection process of the document management system. The process will be described below in detail with reference to FIGS. 11 and 12. The flowchart of the automatic document collection process in FIG. 12 shows steps after the user A has logged in to the document management system. Note that the main control unit 200 of the Web application server PC 20 executes the automatic document collection process while outputting process instructions to the units in the document management server PC 40. However, FIG. 12 illustrates not the instruction exchanges as in FIG. 8 but only the process of the main control unit 200 to avoid complexity.

In step S400, the main control unit 200 acquires the user characteristics of the user A held by the session storage unit 202. Note that the main control unit 200 may instruct the user information operation unit 300 to acquire the user characteristics of the user A from the user information storage unit 301, as indicated by a process P32 in FIG. 11.

In step S401, the main control unit 200 instructs the document retrieving unit 402 to execute document retrieval based on the user characteristics acquired in step S400 (process P33 in FIG. 11). Setting an OR condition for keywords which are the values of the items of the user characteristics, the document retrieving unit 402 instructs the document information operation unit 400 to retrieve a document satisfying the condition from the document information storage unit 401. More specifically, for the user A (“Kazuo Haraguchi”), the retrieval is performed using “design 1”, “document management”, and “installer” of the user characteristics as keywords. In this document extraction process, documents associated with similar users may be extracted as a retrieval result.

If it is determined in step S402 that the document retrieving unit 402 found no document satisfying the condition in step S401, step S403 is executed. In step S403, the main control unit 200 requests the Web UI creation unit 203 to create an error page to notify the user that no document that matches the user characteristics was found. The error page is returned to the Client PC 10 via the data transmission/reception unit 201 as a response and displayed on the Web browser of the Client PC 10.

If it is determined in step S402 that the document retrieving unit 402 found a document satisfying the condition, the main control unit 200 acquires the document list of the retrieval result in step S404. Next, the main control unit 200 extracts, in the document list of the retrieval result, only documents accessible by the user A from the document information storage unit 401 via the document information operation unit 400.

If it is determined in step S405 that no document accessible by the user A was extracted in step S404, step S403 is executed. In step S403, the main control unit 200 requests the Web UI creation unit 203 to create an error page to notify the user that no document list accessible by the user was found. The error page is returned to the Client PC 10 via the data transmission/reception unit 201 as a response and displayed on the Web browser of the Client PC 10.

If it is determined in step S405 that a document list accessible by the user A was found by the retrieval based on the user characteristics and extracted, the process advances to step S406. In step S406, the main control unit 200 instructs the document classification unit 404 to confirm an item having the maximum count (weight) in the document attributes of each document of the document list.

In step S407, the document classification unit 404 classifies the documents of the confirmed document list based on the item having the maximum count (weight) in the document attributes. More specifically, if “belonging section” has the maximum count (weight) in the document attributes of a document, the document is classified into the belonging section “design 1”.

In step S408, the main control unit 200 receives the list of documents 1101 in FIG. 11 classified by the document classification unit 404 in step S407 (process P34 in FIG. 11). Next, the main control unit 200 requests the Web UI creation unit 203 to create a page which displays the list of documents automatically collected and classified in accordance with the user characteristics (1102 in FIG. 11). The page is returned to the Client PC 10 via the data transmission/reception unit 201 as a response and displayed on the Web browser of the Client PC 10 as a page after login of each user (process P35 in FIG. 11).

(Example of Document Collection Result Display Screen)

FIG. 13 shows an example of a user interface (UI) which displays a document collection result after login to the Client PC 10 in the document management system.

In a document display area 1202, the document collection result classified in accordance with the characteristics of the user A is displayed. More specifically, lists of automatically collected and classified documents are displayed in the areas of the belonging section “design 1”, the project “document management” in charge of the user, and the work “installer” in the project in charge of the user.

In FIG. 13, newly arrived documents are displayed, or the UI is customized. A user area 1201 to select a folder link highly relevant to the user and an area 1203 to operate or control the documents are also displayed.

The form, configuration, and control of the Web UI (HTML) serving as a user interface are not limited to those of the example shown in FIG. 13. Any other configuration is usable if HTML to implement necessary functions is created.

(Index Candidate Information Creation Process)

As shown in FIG. 8, the user A accesses (logs in to), via the browser of the Client PC 10, the Web application to provide the functions of the document management system, and executes document registration. At this time, the index candidate information creation process automatically runs (step S206 in FIG. 8). This makes it possible to display, on the Web browser of the Client PC 10, index candidate information to be set for the registration target document (process P27 in FIG. 14).

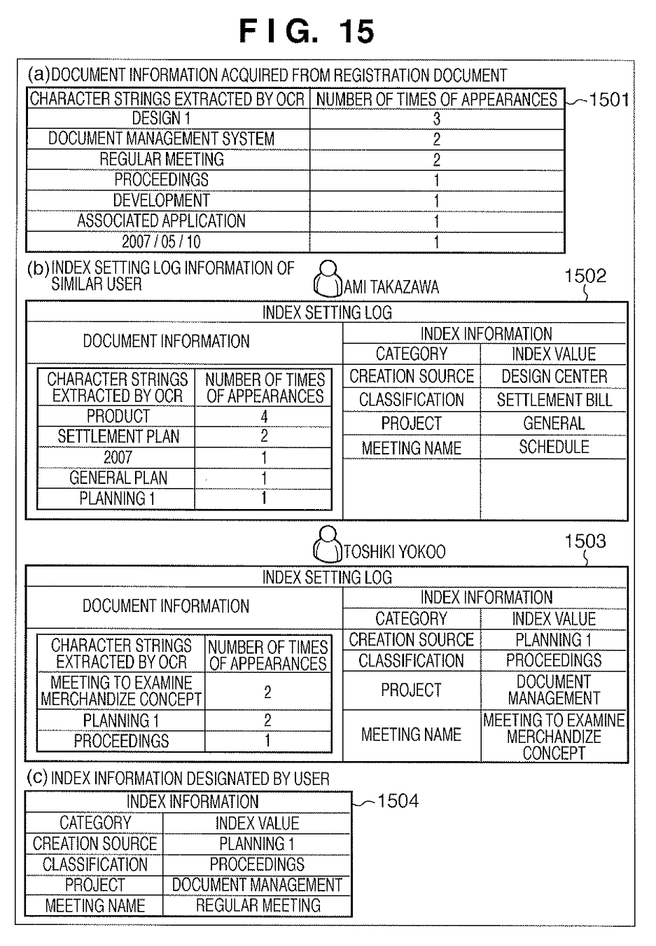

FIG. 15 shows an example of data to be used to create index candidate information in the document management system. FIGS. 16, 17, and 18 are flowcharts illustrating the sequence of the index candidate information creation process when registering a document in the document management system. In this embodiment, the process is performed in the document management server PC 40.

The process in step S206 of FIG. 8 will be described below in detail with reference to FIG. 16. Note that FIG. 16 assumes that user characteristic information and document information have been acquired in the process shown in FIG. 8. The index candidate information creation process is executed by the index candidate information creation unit 406 in the document management server PC 40.

In step S500, the user characteristic information and document information acquired in steps S202 and S203 are compared to determine whether any matching information (keywords) exists. The comparison process in step S500 will be described using a detailed example assuming that the user “Kazuo Haraguchi” executes document registration. In the comparison process in step S500, the user characteristic information of the user “Kazuo Haraguchi” is simply compared with the document information acquired from the registration target document. These pieces of information include “design 1” and “document management” as matching information (keywords). The example of (a) in FIG. 15 represents document information 1501 acquired from the registration document in step S205. In the user characteristics of the user “Kazuo Haraguchi” shown in FIG. 6, the information (keywords) “design 1” and “document management” match those of the document information.

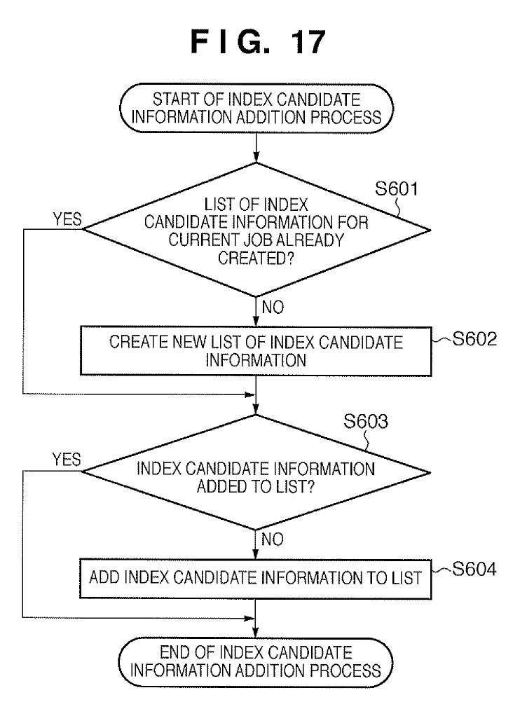

If it is determined in step S500 that matching information exists, the information is added to the index candidate information in step S501. The process of adding information to the index candidate information will be described later with reference to FIG. 17.

In step S502, the index candidate information creation unit 406 instructs the user information operation unit 300 to acquire information of users who have user characteristics similar to those acquired in step S202 and have a predetermined key matching the user characteristics (process P23 in FIG. 14). A similar user is determined by comparison based on an OR condition using a predetermined key set as a “similar user” key (a plurality of similar user keys can be set) in the user characteristic table shown in FIG. 6. A user having a matching key is determined as a user (to be referred to as a similar user hereinafter) having similar user characteristics.

A mere example has been described above. A similar user may be specified using another keyword. Alternatively, users may be designated directly so that, for example, the user characteristics of the user B should be referred to (regarded as a similar user), and the user characteristics of a user C should not be referred to (not regarded as a similar user).

In the examples shown in FIGS. 6 and 15, the similar user retrieval key of the user “Kazuo Haraguchi” is “project”. The users “Ami Takazawa” and “Toshiki Yokoo” whose project key matches that of the user “Kazuo Haraguchi” are determined as similar users.

In step S503, the index candidate information creation unit 406 instructs the user information operation unit 300 to retrieve the user characteristics of the similar users acquired in step S502 and determines whether an index setting log is held. If index setting log information is held (1502 and 1503 in (b) of FIG. 15), the log information is acquired and stored in the session storage unit 202 in step S504.

If a lot of pieces of log information to refer to exist, they may be narrowed down. For example, regarding the user characteristics of a similar user, the pieces of index setting log information are narrowed down in accordance with a period or season based on the storage date of each index setting log information. Alternatively, a character string is designated in advance. When the character string designated in advance is extracted by the OCR process or full-text search, that is, when specific document information is detected, it may be excluded from the index candidate information, or its priority in the index candidate information may be changed.

In step S505, the document information acquired in step S202 is compared with the index setting log information of each similar user acquired in step S504. It is determined whether any matching information (keywords) exists. This comparison further narrows down the similar users acquired in step S502.

In the example of (b) in FIG. 15, “proceedings” in the document information of the user “Kazuo Haraguchi” matches the document information of the index setting log information of the user “Toshiki Yokoo”. However, the index setting log information of the user “Ami Takazawa” contains no matching information. That is, the similar user to be referred to in the index candidate information creation process of the user “Kazuo Haraguchi” is “Toshiki Yokoo”. In the example described above, the number of similar users to be referred to is one. However, a plurality of similar users may be referred to.

In step S506 (to be described later with reference to FIG. 17), the index setting log information of the similar user acquired in step S505 is added to the index candidate information.

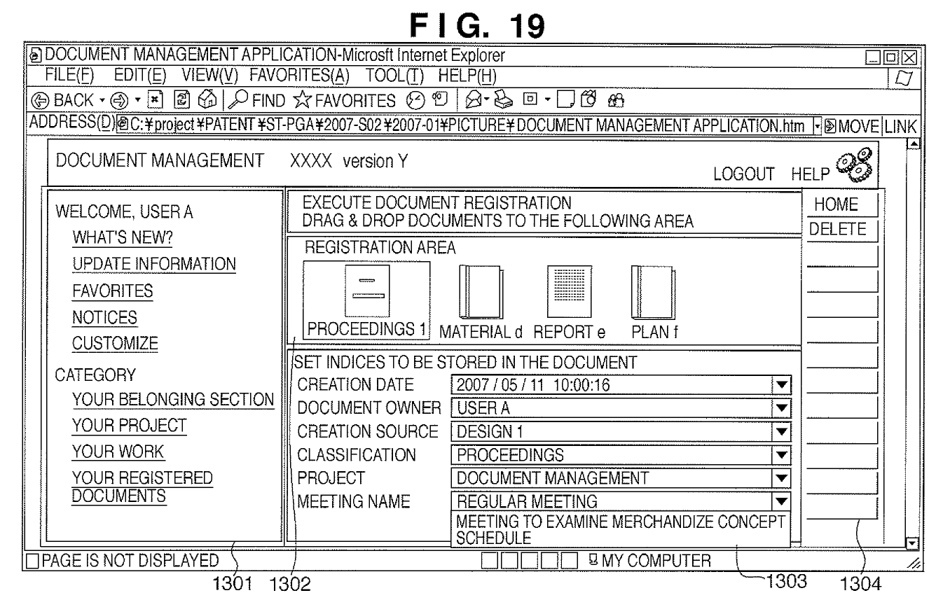

In the example of (c) in FIG. 15, the user designates index information 1504 on a UI displayed as in FIG. 19. In steps S210 and S211 of FIG. 8, the designated index information is acquired and transmitted to the document management server PC 40.

(Index Candidate Information Addition Process)

The index candidate information addition process in steps S501 and S506 of FIG. 16 will be described with reference to FIG. 17.

In step S601, the index candidate information creation unit 406 determines whether a list for temporarily managing index candidate information has already been held in a list storage unit (not shown) of the index candidate information creation unit 406. If it is determined that the list is not held, preparation for creating new index candidate information is done by, for example, creating an empty list for managing index candidate information in the list storage unit (S602). Then, the process advances to step S603.

In step S603, it is confirmed whether the index candidate information to be now added already exists in the index candidate information list held in the list storage unit. Only when the index candidate information does not exist, the index candidate information is added to the index candidate information list in step S604.

(Index Setting Log Information Storage Process)

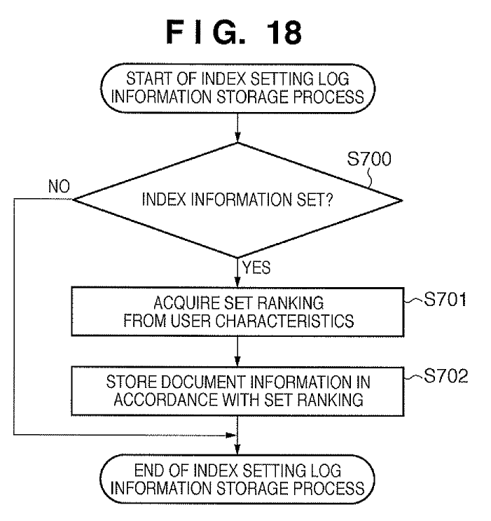

FIG. 18 is a flowchart of the process of storing index setting log information in the user characteristic table in step S216 of FIG. 8. The index setting log information can be stored either in the session storage unit 202 or in the user information storage unit 301 via the user information operation unit 300. This process is mainly executed by the main control unit 200 in the Web application server PC 20.

In step S700, the main control unit 200 determines whether index information has been acquired in step S210. Only when index information has been acquired, set ranking information is acquired, in step S701, from the user characteristics held in the session storage unit 202 (FIG. 6). In step S702, the main control unit 200 specifies document information to be held in the session storage unit 202 or the user information storage unit 301 in accordance with the set ranking acquired in step S701.

In this embodiment, the set ranking is used for the purpose of holding logs for only some of the pieces of document information acquired from the registration document. However, another limiting method may be used to hold the document information logs, or all pieces of document information may be held.

(Example of Document Registration and Index Information Setting Window)

FIG. 19 shows an example of a user interface (UI) for document registration and index information setting, which is displayed upon pressing a “register” button displayed in the operation/control area 1203 in FIG. 13.

When the user in a user area 1301 drags and drops a file from, for example, a Windows® folder to a document registration area 1302, the Client PC 10 internally transmits the document to the Web application server PC 20. The pieces of index candidate information created in step S204 are acquired and presented to the user as choices in an index information setting area 1303. The user registers the document by designating desired keywords in the list of choices. A detailed description of an operation/control area 1304 will be omitted here.

In this example, the pieces of designated index information are assumed to be stored when the focus on the selected document has moved, or the user has logged out. However, a button may be prepared to make the user intentionally designate the storage timing. Only an example has been described above in which the user designates pieces of settable index information from the choices. However, there may be provided a means for causing the user to input a desired keyword which does not exist as a choice.

(Example of Window for Retrieval Condition Setting/Retrieval Instruction by Index Information)

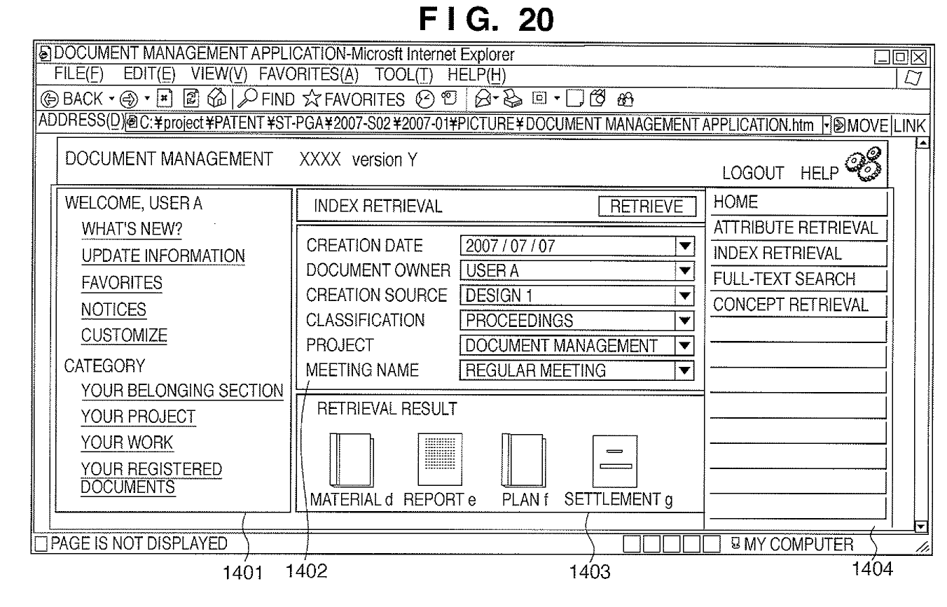

FIG. 20 shows an example of a user interface (UI) to execute retrieval condition setting/retrieval by index information, which is displayed upon pressing an “advanced retrieval” button displayed in the operation/control area 1203 in FIG. 13.

Pieces of index information set for documents accessible by the user are displayed in a retrieval condition setting area 1402.

When retrieval is executed based on the pieces of index information designated in the retrieval condition setting area 1402, documents for which the pieces of index information are set are displayed in a retrieval result display area 1403 as a retrieval result.

A detailed description of a user area 1401 and an operation/control area 1404 will be omitted.

### Example of Process of Document Management System of Second Embodiment

The second embodiment of the present invention will be described with reference to FIGS. 1 to 18 and 21.

The process is different from that of the document management system according to the first embodiment when a mail server (not shown in FIG. 1) has transmitted mail with an attached file to a Client PC 10 or a multi-function peripheral 50. At this time, index information is automatically selected from pieces of index candidate information and automatically stored in the document management system as index information assigned to the attached document.

(Automatic Index Information Assigning Process after Mail Reception)

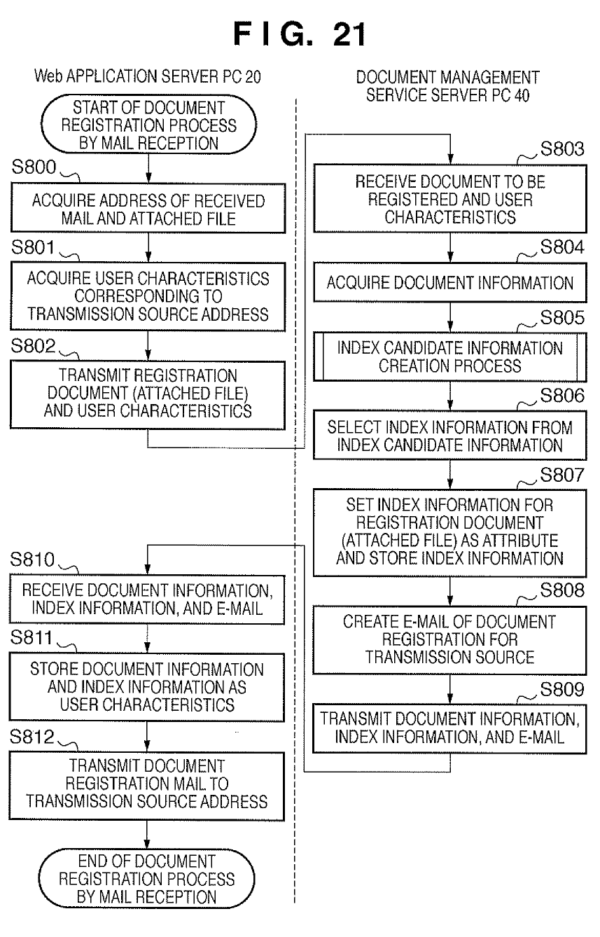

FIG. 21 is a flowchart illustrating the sequence of a process of automatically storing an attached file assigned index information in the document management system upon receiving mail with an attached file in the document management system according to the second embodiment.

The process will be described below in detail with reference to FIG. 21. The explanation will be made using the Client PC 10. However, the Client PC 10 may be replaced with the multi-function peripheral 50.

In step S800, mail with an attached file is received from the Client PC 10 or the multi-function peripheral 50 via a mail server (not shown) by the e-mail function (not shown) of a data transmission/reception unit 201. At the time of mail reception, a main control unit 200 acquires the transmission source address of the mail received from the Client PC 10 or the multi-function peripheral 50 and the attached file via the data transmission/reception unit 201.

In this example, the transmission source address is acquired. However, any other information such as a mail header or a mail text may be acquired if it contains information to identify a user.

Processes in steps S801 and S802 are executed by a Web application server PC 20.

In step S801, the main control unit 200 instructs a user information operation unit 300 to perform retrieval using the transmission source address acquired in step S800, thereby identifying the user having the transmission source address. The main control unit 200 acquires the user characteristic information of the identified user.

In step S802, the main control unit 200 transmits the registration document (attached file) and the user characteristics acquired in steps S800 and S801 to a document management server PC 40 via the data transmission/reception unit 201.

Processes in steps S803 to S809 are executed by the document management server PC 40.

In step S803, the document management server PC 40 receives the registration document and the user characteristics from the Web application server PC 20. In step S804, a document information acquiring unit 405 acquires document information from the registration document by performing image processing such as an OCR process or character string extraction using, for example, a full-text search. Note that acquisition of attributes and the like already set for the document may be executed in addition to the above-described image processing. The target of the document information acquiring process is assumed to be the attached file received in step S800. However, it may be the mail text or contain the mail header and any other information.

In step S805, pieces of index candidate information are created based on the received user characteristics and the document information acquired in step S804. The index candidate information creation process is the same as that described in detail with reference to, for example, FIG. 16.

In step S806, an index candidate information creation unit 406 determines pieces of index information from the pieces of index candidate information. In step S806, the pieces of index information are arbitrarily selected from the pieces of index candidate information. When determining the index information, a priority is set for each index information by a certain kind of weighting, and pieces of index information are selected in accordance with the priority. In this embodiment, for example, index candidate information added in steps S504 to S506 is selected as index information. This makes it possible to automatically assign, to the document, index information which has been used in the past so as to facilitate document retrieval and reuse by any user other than the document registrant afterward. All pieces of index candidate information may be determined as index information. This process includes the index information creation process or the index information selection process.

In step S807, a document information operation unit 400 sets, as attributes, the index information determined in step S804 for the registration document (attached file) received in step S803 and stores it in a document information storage unit 401.

In step S808, a mail creation unit 407 creates, for the above-described transmission source address, e-mail whose text describes that the attached file has been registered. The document information described in the mail text includes the file name, storage folder, storage date/time, and index information set values of the registered attached file. Instead of describing the information in the mail text, it may be attached to the mail. In step S809, the document management server PC 40 transmits the document information, the index information, and the created e-mail information to the main control unit 200.

Processes in steps S810 to S812 are executed by the main control unit 200 in the Web application server PC 20.

In step S810, the main control unit 200 receives the document information, the index information, and the created e-mail information. In step S811, the relieved document information and index information are added to the user characteristic information of the user identified based on the transmission source address. The main control unit 200 instructs the user information operation unit 300 to store the user characteristic information in a user information storage unit 301.

In step S812, the main control unit 200 transmits the e-mail received in step S810 to the transmission source address using the mail function of the data transmission/reception unit 201 as mail of document registration completion.

The information described in the mail text may also include the index candidate information created in step S806. This enables to provide information useful as setting reference information when the user wants to change the index information of the already registered document afterward.

The process according to the second embodiment allows the user to register a document in the document management system as a document assigned index information automatically selected from pieces of index candidate information only by receiving mail with an attached file. This enables easier document registration. Especially, when mail with an attached file is transmitted to the multi-function peripheral 50, the document can be registered without temporarily transferring it to the Client PC 10 or storing it in the storage device of the multi-function peripheral 50.

The present invention is applicable to a system or an integrated apparatus including a plurality of devices (e.g., host computer, interface device, and printer) or an apparatus including a single device.

The objects of the present invention are also achieved by supplying a storage medium (or recording medium) which records software program codes to implement the functions of the above-described embodiments to a system or apparatus and causing the computer (or CPU or MPU) of the system or apparatus to read out and execute the program codes stored in the storage medium.

In this case, the program codes themselves read out from the storage medium implement the functions of the above-described embodiments. The storage medium that stores the program codes constitutes the present invention.

The functions of the above-described embodiments are implemented not only by causing the computer to execute the readout program codes. The present invention also incorporates a case in which the operating system (OS) running on the computer partially or wholly executes actual processing based on the instructions of the program codes, thereby implementing the functions of the above-described embodiments.

The present invention also incorporates a case in which the program codes read out from the storage medium are written in the memory of a function expansion card inserted to the computer or a function expansion unit connected to the computer, and the CPU of the function expansion card or function expansion unit partially or wholly executes actual processing based on the instructions of the program codes, thereby implementing the functions of the above-described embodiments.

The storage medium to which the present invention is applied stores program codes corresponding to the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-029583, filed Feb. 8, 2008, which is hereby incorporated by reference herein in its entirety.

What is claimed is:

1. A document management apparatus comprising:
a user characteristic information acquiring unit adapted to acquire user characteristic information for identifying a user from login information of the user;
a document information acquiring unit adapted to acquire document information of a document;
an index candidate information creation unit adapted to create pieces of index candidate information to be assigned to the document based on the user characteristic information acquired by said user characteristic information acquiring unit and the document information acquired by said document information acquiring unit;
an index candidate information output unit adapted to output the pieces of index candidate information created by said index candidate information creation unit;
an index information reception unit adapted to receive index information selected by the user from the pieces of index candidate information output by said index candidate information output unit; and
a document registration unit adapted to register the index information received by said index information reception unit in association with the document acquired by said document information acquiring unit.

2. The apparatus according to claim 1, wherein said document information acquiring unit acquires, as the document information, an OCR-extracted character string at a high rank in a number of times of appearance from OCR-extracted character strings in the document.

3. The apparatus according to claim 1, wherein said index candidate information creation unit comprises an addition unit adapted to compare items of the user characteristic information acquired by said user characteristic information acquiring unit with items of the document information acquired by said document information acquiring unit and add the index candidate information concerning items which match each other based on the user characteristic information.

4. The apparatus according to claim 1, wherein said index candidate information creation unit comprises an addition unit adapted to acquire, from log information of another user having user characteristic information whose predetermined items match items of the user characteristic information acquired by said user characteristic information acquiring unit, index information set upon registering a document and add the acquired index information to the index candidate information.

5. The apparatus according to claim 1, wherein said index candidate information output unit comprises a display instruction unit adapted to cause an information processing apparatus of the user to display a user interface which allows selection of the index candidate information.

6. The apparatus according to claim 1, wherein said document registration unit sets the user characteristic information acquired by said user characteristic information acquiring unit for the document in association with the index information and registers the document.

7. The apparatus according to claim 6, further comprising a document extraction unit adapted to compare the user characteristic information acquired by said user characteristic information acquiring unit with the user characteristic information set for the document registered by said document registration unit in association with the index information and extract, as a document associated with the user, a document having user characteristic information whose predetermined items match items of the set user characteristic information.

8. A method of managing documents, comprising the steps of:
acquiring user characteristic information for identifying a user from login information of the user;
acquiring document information of a document;
creating pieces of index candidate information to be assigned to the document based on the user characteristic information acquired in the user characteristic information acquiring step and the document information acquired in the document information acquiring step;
outputting the pieces of index candidate information created in the index candidate information creating step;
receiving index information selected by the user from the pieces of index candidate information output in the index candidate information outputting step; and
registering the index information received in the index information receiving step in association with the document acquired in the document information acquiring step.

9. The method according to claim 8, wherein in the document information acquiring step, an OCR-extracted character string at a high rank in a number of times of appearance is acquired as the document information from OCR-extracted character strings in the document.

10. The method according to claim 8, wherein the index candidate information creating step comprises the step of comparing items of the user characteristic information acquired in the user characteristic information acquiring step with items of the document information acquired in the document information acquiring step and adding the index candidate information concerning items which match each other based on the user characteristic information.

11. The method according to claim 8, wherein the index candidate information creating step comprises the step of acquiring, from log information of another user having user characteristic information whose predetermined items match items of the user characteristic information acquired in the user characteristic information acquiring step, index information set upon registering a document and adding the acquired index information to the index candidate information.

12. The method according to claim 8, wherein the index candidate information outputting step comprises the step of causing an information processing apparatus of the user to display a user interface which allows selection of the index candidate information.

13. The method according to claim 8, wherein in the document registering step, the user characteristic information acquired in the user characteristic information acquiring step is set for the document in association with the index information, and the document is registered.

14. The method according to claim 13, further comprising the step of comparing the user characteristic information acquired in the user characteristic information acquiring step with the user characteristic information set for the document registered in the document registering step in association with the index information and extracting, as a document associated with the user, a document having user characteristic information whose predetermined items match items of the set user characteristic information.

15. A computer-readable storage medium storing a program which causes a computer to execute the steps of a document management method of claim 8.

16. A document management apparatus comprising:
a mail reception unit adapted to receive mail;
a user characteristic information acquiring unit adapted to acquire user characteristic information for identifying a user from a transmission source address of the received mail;
a document information acquiring unit adapted to acquire document information from an attached file of the received mail;
an index information creation unit adapted to create index information to be assigned to the document based on the user characteristic information acquired by said user characteristic information acquiring unit and the document information acquired by said document information acquiring unit;
a document registration unit adapted to register the index information created by said index information creation unit, in association with the document acquired by said document information acquiring unit; and
a mail transmission unit adapted to transmit the mail representing completion of document registration to the transmission source address, the mail having a text containing the index information created by said index information creation unit.

17. The apparatus according to claim 16, wherein said index information creation unit comprises:
an index candidate information creation unit adapted to create pieces of index candidate information to be assigned to the document based on the user characteristic information acquired by said user characteristic information acquiring unit and the document information acquired by said document information acquiring unit; and
an index information selection unit adapted to select index information from the pieces of index candidate information created by said index candidate information creation unit.

18. The apparatus according to claim 16, wherein said mail transmission unit includes, in the mail representing completion of document registration, the index candidate information created by said index candidate information creation unit.

19. A method of managing documents, comprising the steps of:
receiving mail;
acquiring user characteristic information for identifying a user from a transmission source address of the received mail;
acquiring document information from an attached file of the received mail;
creating index information to be assigned to the document based on the user characteristic information acquired in the user characteristic information acquiring step and the document information acquired in the document information acquiring step;
registering the index information created in the index information creating step in association with the document acquired in the document information acquiring step; and
transmitting the mail representing completion of document registration to the transmission source address, the mail having a text containing the index information created in the index information creating step.

20. The method according to claim 19, wherein the index information creating step comprises the steps of:
creating pieces of index candidate information to be assigned to the document based on the user characteristic information acquired in the user characteristic information acquiring step and the document information acquired in the document information acquiring step; and
selecting index information from the pieces of index candidate information created in the index candidate information creating step.

21. The method according to claim 20, wherein in the mail transmitting step, the mail representing completion of document registration includes the index candidate information created in the index candidate information creating step.

22. An information processing apparatus comprising:
a login unit adapted to log in to a document management apparatus for registering and managing documents;
a document transmission unit adapted to transmit a document to be registered;
an index candidate information reception unit adapted to receive pieces of index candidate information created and output by the document management apparatus based on user characteristic information acquired from login information and document information acquired from the document; and
an index information transmission unit adapted to transmit index information selected by a user from the pieces of received index candidate information to register the index information in association with the document to be registered.

23. The apparatus according to claim 22, further comprising a display unit adapted to display a user interface which allows selection of the received index candidate information.

24. The apparatus according to claim 23, wherein
the information processing apparatus communicates with the document management apparatus via a network, and
the document management apparatus causes the user to log in, via a Web browser, to a document management application for registering and browsing the documents, and said display unit displays, on the Web browser, the index candidate information received by said index candidate information reception unit.

25. The apparatus according to claim 22, wherein
the information processing apparatus is an image forming apparatus having a scanner function, and
the document to be registered includes an image read by the scanner function.

26. A method of controlling an information processing apparatus, comprising the steps of:
logging in to a document management apparatus for registering and managing documents;
transmitting a document to be registered;
receiving pieces of index candidate information created and output by the document management apparatus based on user characteristic information acquired from login information and document information acquired from the document; and
transmitting index information selected by a user from the pieces of received index candidate information to register the index information in association with the document to be registered.

27. The method according to claim 26, further comprising the step of displaying a user interface which allows selection of the received index candidate information.

28. The method according to claim 27, wherein
the information processing apparatus communicates with the document management apparatus via a network, and
the document management apparatus causes the user to log in, via a Web browser, to a document management application for registering and browsing the documents, and in the displaying step, the index candidate information received in the index candidate information receiving step is displayed on the Web browser.

29. The method according to claim 26, wherein
the information processing apparatus is an image forming apparatus having a scanner function, and
the document to be registered includes an image read by the scanner function.

30. A computer-readable storage medium storing a program which causes a computer to execute the steps of an information processing apparatus control method of claim 26.

31. A document management system including an information processing apparatus for registering and browsing documents, and a document management apparatus for managing the registered documents,
the document management apparatus comprising:
a user characteristic information acquiring unit adapted to acquire user characteristic information for identifying a user from login information of the user;
a document information acquiring unit adapted to acquire document information of a document;
an index candidate information creation unit adapted to create pieces of index candidate information to be assigned to the document based on the user characteristic information acquired by said user characteristic information acquiring unit and the document information acquired by said document information acquiring unit;
an index candidate information output unit adapted to output the pieces of index candidate information created by said index candidate information creation unit;
an index information reception unit adapted to receive index information selected by the user from the pieces of index candidate information output by said index candidate information output unit; and
a document registration unit adapted to register the index information received by said index information reception unit in association with the document acquired by said document information acquiring unit.

32. The system according to claim 31, wherein the information processing apparatus comprises:
an index candidate information reception unit adapted to receive the pieces of index candidate information output by said index candidate information output unit; and
a display unit adapted to display a user interface which allows selection of the index candidate information received by said index candidate information reception unit.

33. The system according to claim 32, wherein
the information processing apparatus communicates with the document management apparatus via a network, and
the document management apparatus causes the user to log in, via a Web browser, to a document management application for registering and browsing the documents, and said display unit displays, on the Web browser, the index candidate information received by said index candidate information reception unit.

34. The system according to claim 32, wherein
the information processing apparatus is an image forming apparatus having a scanner function, and
a document to be registered includes an image read by the scanner function.

35. A method of managing documents in a document management system including an information processing apparatus for registering and browsing the documents, and a document management apparatus for managing the registered documents, comprising the steps of:
acquiring user characteristic information for identifying a user from login information of the user;
acquiring document information of a document;
creating index candidate information to be assigned to the document based on the user characteristic information acquired in the user characteristic information acquiring step and the document information acquired in the document information acquiring step;
displaying the pieces of index candidate information created in the index candidate information creating step;
receiving index information selected by the user from the pieces of index candidate information displayed in the index candidate information displaying step; and
registering the index information received in the index information receiving step in association with the document acquired in the document information acquiring step.
